(19) United States
(12) Patent Application Publication
(10) Pub. No.: US 2018/0018203 A1
(43) Pub. Date: Jan. 18, 2018

(54) METHOD AND SYSTEM FOR ACCELERATING ORCHESTRATION IN NETWORK FUNCTION VIRTUALIZATION (NFV) ENVIRONMENT

(71) Applicant: ZTE USA (TX), Austin, TX (US)

(72) Inventor: BHUMIP KHASNABISH, Lexington, MA (US)

(21) Appl. No.: 15/648,871

(22) Filed: Jul. 13, 2017

Related U.S. Application Data
(60) Provisional application No. 62/362,315, filed on Jul. 14, 2016.

(51) Int. Cl. G06F 9/50; H04L 29/08; G06F 9/455; H04L 12/931; G06F 9/48

(52) U.S. Cl. CPC G06F 9/5077; H04L 67/16; G06F 9/5027; G06F 9/45558; G06F 9/4881; H04L 49/70

(57) ABSTRACT

Novel method to accelerate an NFVO block in an NFV-based network, and system to execute the method. These include the use of accelerators from a pool of accelerators in NFVO in a selective way, and adding accelerators dynamically to NFVO sub-blocks to optimize operations.

### BACKGROUND

Network Operators' networks typically comprise a large variety of uniquely configured hardware appliances, Launching a new network service often requires yet another variety of appliance. This situation creates challenges such as capital investment requirements for the appliances, and a rarity of skills necessary to integrate and operate the increasingly complex hardware appliance-based network. Moreover, hardware-based appliances reach their nominal end of life fairly rapidly, Perhaps worse, hardware lifecycles tend to become shorter as technology and services innovation progresses and accelerates.

This can inhibit the roll out of new revenue earning network services, and can result in an undesirable lack of flexibility in the network.

Network Functions Virtualization (NFV) addresses these problems by leveraging standard IT virtualization technology to consolidate many network equipment types. In this way, the equipment types can be embodied in industry standard high volume servers, switches, and storage, which can be located in data centers, network nodes, and end user premises. A comparison of these approaches is illustrated in FIG. 1, reproduced from “FIG. 1: Vision for Network Functions Virtualisation” from the document “Network Functions Virtualisation—Introductory White Paper”, presented Oct. 22-24, 2012 at the “SDN and OpenFlow World Congress”, Darmstadt-Germany and at this writing available for download at http://portal.etsi.org/NFV/NFV_White_Paper.pdf.

NFV standards are currently under development under the auspices of ETSI, and relevant documents may be obtained from http://www.etsi.org. The entireties of the particular ETSI and any other documents mentioned in this disclosure are hereby incorporated by reference as if fully set forth. Terminology for the main concepts are set forth in ETSI GS NFV 003 V1.2.1 (2014-12), “Network Functions Virtualisation (NFV); Terminology for Main Concepts in NFV”. Virtualization requirements are set forth in ETSI GS NFV 004 V1.1.1 (2013-10), “Network Functions Virtualisation (NFV); Virtualisation Requirements”. Usage cases are presented in ETSI GS NFV 001 V1.1.1 (2013-10), “Network Functions Virtualisation (NFV); Use Cases”. Other documents relevant to this disclosure include ETSI GS NFV-MAN 001 V1.1.1 (2014-12), “Network Functions Virtualisation (NFV); Management and Orchestration”; ETSI GS NFV-IFA 001 V1.1.1 (2015-12), “Network Functions Virtualisation (NFV); Acceleration Technologies; Report on Acceleration Technologies & Use Cases”; ETSI GS NFV-IFA 009 V1.1.1 (2016-07), “NFV Functions Virtualisation (NFV); Management and Orchestration; Report on Architectural Options”. In this disclosure, virtualized network functions and other entities may be referred to herein as “blocks” or “sub-blocks”, The blocks, sub-blocks, and groups of sub-blocks, as described in Section 6.4 of the above-mentioned GS NFV-IFA 009, that may utilize the acceleration mechanism(s) may be different for different services.

Various network resources may be orchestrated to realize the network functions being virtualized. The objective of NFV Orchestration (NFVO) is to coordinate the realization of network function virtualization where and when needed. Depending on the functions required and the available resources during periods of high demand, certain aspects of NFVO may slow down or even malfunction. This can be mitigated by accelerating those and related aspects of NFVO. Thus, the objective of NFV Orchestration Acceleration (NOA) is to achieve rapid development, deployment and delivery of Network Service (NS) using faster management of Virtual Network Functions (VNFs). NS and VNF as used in this context are defined in the document “Terminology for Main Concepts in NFV”, ETSI GS NFV 003, V.1.2.1″, The act of Orchestration Acceleration involves adding acceleration mechanisms to an NFV block, or to one or more sub-blocks of NFVO. Aspects of NFVO that may be accelerated include processing acceleration, interface acceleration, storage acceleration, and bandwidth acceleration. Particulars of some aspects of NFV acceleration have been set forth in the document “NFV Acceleration Technologies, V.1.1.1”.

The NFVO block or the groups of sub-blocks that will utilize the acceleration mechanism(s) may be different for different services. A service-specific group of sub-blocks may assign one sub-block as the master entity for the service that is being developed or delivered, This is described in Sec. 6.4 of the document entitled “NFV Management and Orchestration; Report on Architectural Options”, available at https://portal,etsi.org/webapp/workProgram/Report_Workitem.asp?wki_id=45986, April 2016.

NFV can be applied to any data plane packet processing and control plane function in fixed and mobile network infrastructures, and transforms the way that network operators architect networks. It involves the virtualization and implementation of network functions in software that can run on industry standard server hardware. FIG. 1 compares the classical approach to network architecture that uses purpose-built and siloed network appliances, with the more flexible Network Virtualization approach. As shown, in the classical approach common network appliances used include routers, border controllers, gateways, and the like. This approach results in the fragmented use of proprietary appliances realized as non-commodity hardware. Further, it requires physical installation of appliances at particular sites.

In contrast, the network visualization approach uses virtualized network entities that can be instantiated in the network when and where needed using existing standard equipment that may already be installed. Capital investment in new hardware can be delayed until the existing equipment is no longer sufficient to provide the desired virtualized network functions. Moreover, when more hardware is needed it can be added using economical, standard high volume servers, storage, and switches to host an effectively unlimited number and variety of virtual appliances. An operational advantage of a network configured and operated in this way is that it can be orchestrated automatically. Virtual appliance implementations from independent software vendors can be used, and they can be implemented remotely, when and where the corresponding virtual network functions (VNF) are needed.

Thus, network functions virtualization (NFV) is a network architecture concept that extends technologies of information technology virtualization to virtualize entire classes of network node functions. The network node classes are virtualized into building blocks that interconnect to realize various network services, such as virtualized load balancers, firewalls, intrusion detection devices, WAN accelerators, session border controllers, and the like. The use of NFV Orchestration Acceleration (NOA) can provide for rapid development, deployment, and delivery of Network Service (NS) using faster management of Virtual Network Functions (VNFs).

The act of Orchestration Acceleration involves adding acceleration mechanisms to an NFV block, or to one or more sub-blocks of an NFV Orchestrator (NFVO) as part of a NFV Management and Orchestration (MANO system. The NFVO block of MANO is tasked with requirements to support many features, functions, catalogues, reference points, etc. In periods of high demand, the NFVO block may become overburdened, One way to counter this effect is to deploy more NFV entities; another is to accelerate certain aspects of communication and network functionality, such as processing acceleration, interface acceleration, network acceleration, storage acceleration, bandwidth (allocation) acceleration, and the like.

### SUMMARY

Novel approaches to overcome the overburdening of an NFVO block in an NFV-based network are disclosed, These include the use of accelerators from a pool of accelerators in NFVO in a selective way; and adding accelerators dynamically to NFVO sub-blocks to optimize operations.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims. In the drawings:

FIG. 1 compares the classical network appliance approach to providing network functionality and services, to the network virtualization approach.

FIG. 2 shows the NFV MANO architectural framework with reference points.

FIG. 3 depicts NFVO usage of accelerators in regular (integrated) NFVO option in MANO.

FIG. 4 shows NFVO usage of accelerators in split-NFVO option in MANO.

FIG. 5 shows a regular NFV Orchestrator (NFVO).

FIG. 6 shows an NFV Orchestrator (NFVO) with split NSO and RO, and housings for accelerators.

FIG. 7 displays the message flow sequence for VNF State learning in regular

NFVO architecture.

FIG. 8 shows expedited learning of VNF states when the NFV Orchestrator (NFVO) is split into NSO and RO along with housings for accelerators. These housings contain acceleration resources based on situation specific Accelerators obtained temporarily from a pool of acceleration resources.

### DETAILED DESCRIPTION

It is to be understood that the figures and descriptions provided herein may have been simplified to illustrate aspects that are relevant for a dear understanding of the herein described processes, machines, manufactures, and/or compositions of matter, while eliminating, for the purpose of clarity, other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art. Furthermore, the following descriptions are provided as teaching examples and should not be construed to limit the scope of the invention.

Rather, the scope of the invention is defined by the claims. Although specific details may be disclosed, embodiments may be modified by changing, supplementing, or eliminating many of these details.

NFV relies upon, but differs from, traditional server virtualization techniques used in enterprise IT. In NFV, a virtualized network function (VNF) may be realized using one or more virtual machines running various software and executing processes. The virtual machines may be run on top of standard high-volume servers, switches, and storage devices, which may include cloud computing infrastructure. Because the network functions and processes are realized and executed only when needed on generic hardware, most or all of the costs associated with installing conventional appliances may be avoided. For example, virtual session border controllers may be deployed as needed to protect a network without the cost and complexity of obtaining and installing physical network protection units.

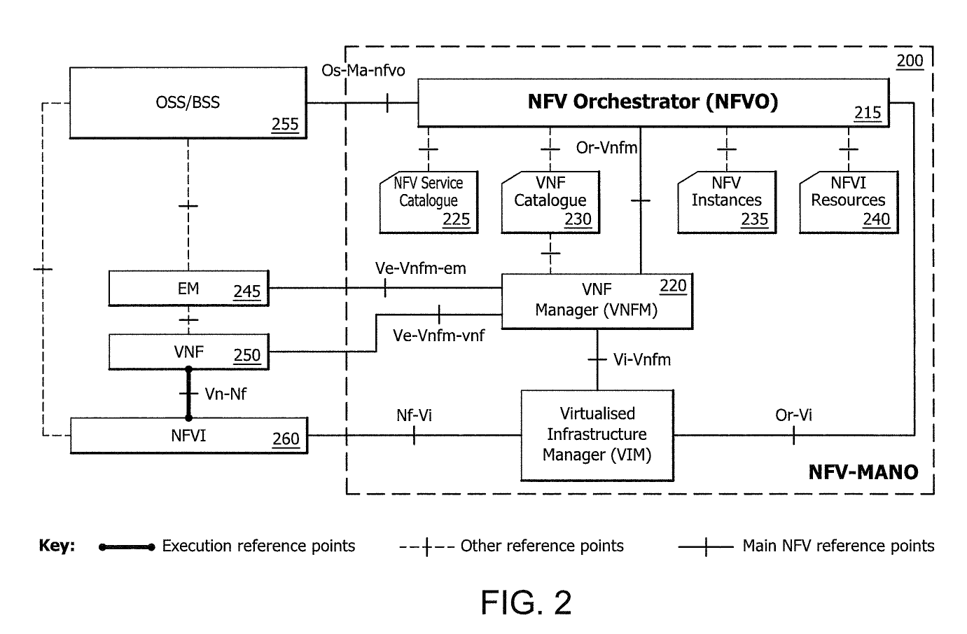

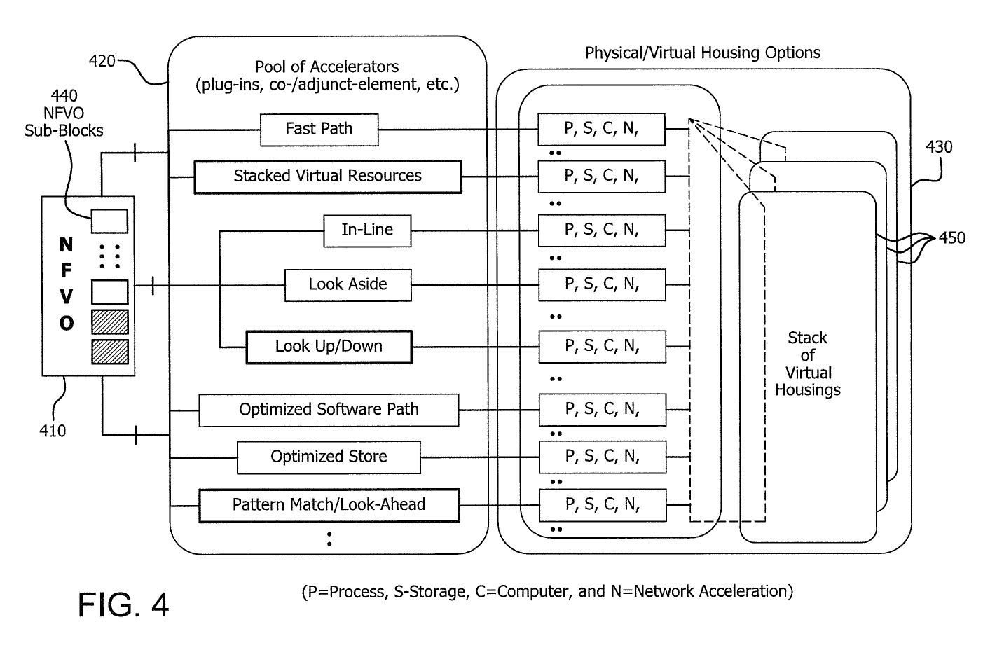

FIG. 2 shows the NFV-MANO architectural framework with reference points that is being developed under the auspices of ETSI. This figure is reproduced from “FIG. 4.1-1: The NFV-MANO architectural framework with reference points” from ETSI GS NFV-IFA 009 V1.1.1 (2016-07) entitled “Network Functions Virtualisation (NFV); Management and Orchestration; Report on Architectural Options”. The framework shown in FIG. 2 relies on a set of principles that support a combination of the concepts of distinct Administrative Domains, and layered management and orchestration functionality in each of those domains.

The following entities are considered by ETSI documents to be within scope of the NFV-MANO architectural framework. Functional blocks identified as belonging to NFV Management and Orchestration (NFV-MANO); other functional blocks that interact with NFV-MANO via reference points; and reference points that enable communications to, from, and within NFV-MANO. Each of the functional blocks has a well-defined set of responsibilities and operates on well-defined entities, using management and orchestration as applicable within the functional block, as well as leveraging services offered by other functional blocks.

The NFV-MANO architectural framework 200 identifies the following NFV-MANO functional blocks. Virtualized infrastructure Manager (VIM) 210; NFV Orchestrator (NFVO) 215; and VNF Manager (VNFM) 220. NFV-MANO architectural framework also identifies the following data repositories. NFV Service Catalogue 225; VNF Catalogue 230; NFV instances repository 235; and NFVI Resources repository 240. The NFV-MANO architectural framework identifies the following functional blocks that share reference points with NFV-MANO, Element Management (EM) 245; Virtualized Network Function (VNF) 250; Operation System Support (OSS) and Business System Support functions (BSS) 255; and NFV Infrastructure (NFVI) 260. Finally, the NFV-MANO architectural framework identifies the following main reference points. Os-Ma-nfvo, a reference point between OSS/BSS and NFVO; Ve-Vnfm-em, a reference point between EM and VNFM; Ve-Vnfm-vnf, a reference point between VNF and VNFM; Nf-Vi, a reference point between NFVI and VIM; Or-Vnfm, a reference point between NFVO and VNFM; Or-Vi, a reference point between NFVO and VIM; and Vi-Vnfm, a reference point between VIM and VNFM. These functional blocks and reference points are defined in the ETSI GS NFV-MAN 001 V1.1.1 document previously mentioned and incorporated by reference.

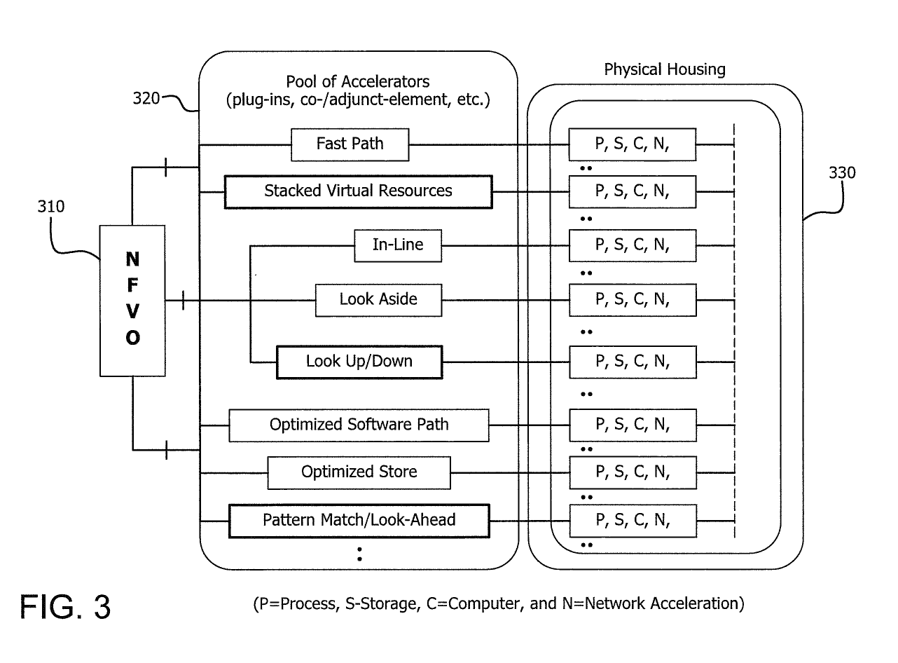

FIG. 3 shows NFVO usage of accelerators to achieve optimization in regular (integrated) NFVO. It depicts NFV Orchestrator (NFVO) 310 usage of accelerators 320 (to achieve Optimization) in regular (integrated) NFVO option in MANO. Conventionally, the accelerators 320 are embodied in shoed physical resources in physical housing 330. As shown, the physical resources can generally include one or more process (P), storage (S), computing (C), or network acceleration (N) resources, depending on the accelerator. The NFVO block is tasked with ensuring requirements are met to support many features, functions, catalogues, reference points, etc., as set forth in ETSI GS NFV-IFA 009. However, as noted previously, the demand to execute many requests simultaneously may overburden the NFVO block, making task execution slower, or more prone to error, or both. To improve task execution, faster response and streamlined operations may be desirable.

There may be many ways to achieve such faster response and streamlined operations. As illustrated in FIG. 4, one option is to split the NFVO 410 into a plurality of sub-blocks 440. This option is disclosed, for example, in ETSI NFV work item IFA020 entitled “Report on NFV Orchestration functional decomposition options”. Moreover, some or all of the accelerators 430, which conventionally are embodied in siloed physical resources in physical housing 330, can instead be embodied as virtualized resources in virtual housing(s) 450. That is, the resources embodying an accelerator can be obtained from a pool of P, S, C, and N resources that do not need to be co-located, and do not need to exist in a particular physical housing. The resources can be dynamically allocated from the pool, configured and modified as needed, and released back to the pool when no longer needed. Other options include the use of accelerators from a pool of accelerators in NFVO in a selective way, and adding accelerators dynamically to NFVO sub-blocks to optimize operations. These options use hardware offload of some of the features and functions of sub-blocks of NFVO. This may enable rapid development and deployment of services that can benefit from the flexible use of features and functions of NFVO. In addition, this may support the development of plug-able MANO components by independent players. These are illustrated in the following via a use case of expedited learning of VNF and NS states.

The objective in this illustrative example is acquisition of the state of, e.g., a VNF and its dissemination so that Network Service (NS) can be made aware of the state even before the information is received through the regular distributed channels to NFVO. In other words, the objective is to use and manage the usage of acceleration resources in NFV orchestration (NFVO) in a new way. The use and management (e.g., discovery, allocation, release, etc.) of accelerators in Virtualized Infrastructure Manager (VIM) has been discussed in ETSI GS NFV-IFA 004 V2.1.1 (2015-04), “Network Functions Virtualsation (NFV); Acceleration Technologies; Management Aspects Specification”. In contrast, NFV components involved in the present example may include a group of sub-blocks or sub-components of NFVO, and may or may not also involve components of VNFM or VIM. This group may dynamically evolve with, for example, a sub-block from NFVO as master. The master could be from Resources Orchestration (RO) sub-block of NFVO, or from Network Services Orchestration (IPSO) sub-block of NFVO. The decision of which to use depends on whether the objective is to learn rapidly the state of a resource (use a sub-block from RO), or an application or service (use a sub-block from NSO).

Achieving rapid determination and assignment of a master for expedited state learning may be affected by coordination among the distributed sub-blocks and sub-components of NFVO, VNFM, and VIM. Therefore, management and orchestration considerations include the VNFs under consideration. The VNFs may publish their state, for example through open APIs, to enable the appropriate sub-blocks of NFVO, VNFM, and VIM to monitor and gather information about current and emerging (predicted) states. NFVO must also be made aware of the states of NS so that NFVO can pre-position resources via appropriate orchestration to fulfill the needs of NS.

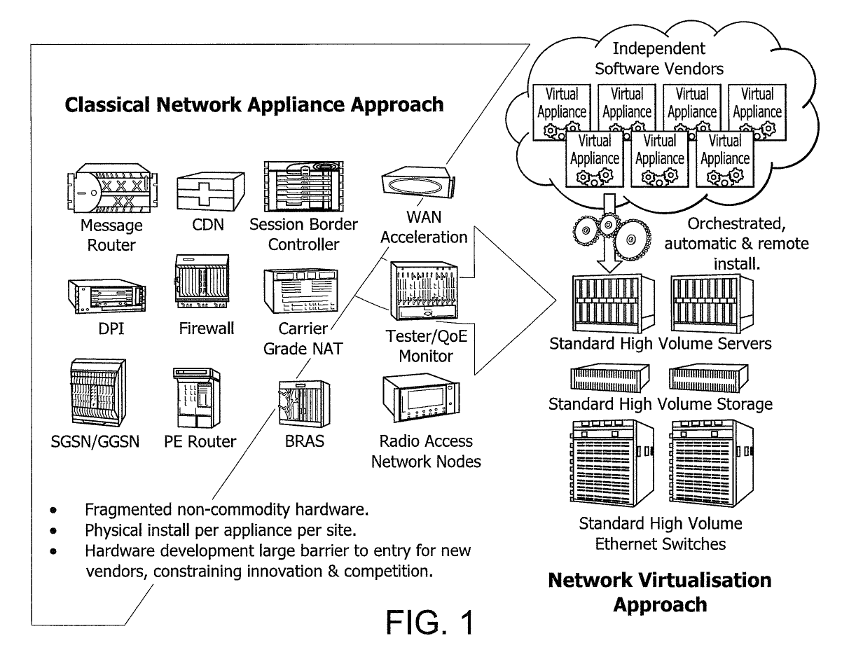

ETSI documents ETSI GS NFV-IFA 001 V1.1.1 (2015-12), “Network Functions Virtualisation (NFV); Acceleration Technologies; Report on Acceleration Technologies & Use Cases” and ETSI GS NFV-IFA 002 V2.1.1 (2016-03), “Network Functions Virtualisation (NFV); Acceleration Technologies; VNF Interfaces Specification” describe various types of accelerators and their usage in NFV environment. However other, different types of accelerators are disclosed herein that are useful for NFVO acceleration. These include stacked virtual resources; look up/down; pattern matching; and look-ahead (i.e., prediction). Accelerators may also include proactive and hybrid mechanisms for accelerated learning of VNF states, Such learning can be achieved by using look-aside/up/down; fast/optimized path; and pattern match/look-ahead resources. Such accelerators are illustrated in FIG. 3 and FIG. 1. Accelerators may also include so-called plug-in anyware modules and add-ons for accelerating, adapting, and/or enhancing RO/NSO/NFVO apps.

Accelerators may also expedite learning of the states of VNF and NS using a combination of distributed and ad-hoc centralized entity-based learning of states. The use of accelerators also helps determine which MANO/NFVO entity will dynamically assume the role of ad-hoc centralized entity so that it can coordinate the learning of the states of VNF and NS for faster response.

The selection or election or assignment of the ad-hoc centralized entity for learning of states of VNF and NS may be based on the specified criteria for target networking and service scenarios, and may include the availability of acceleration resources at the time of decision making. The following is a list of NFVO actions and activities that can benefit from the use of accelerators in the NFVO.

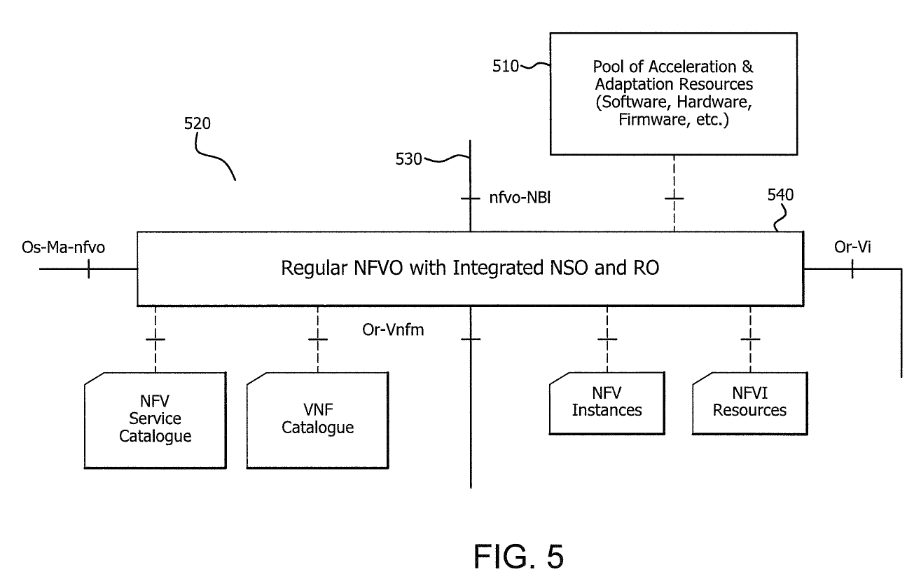

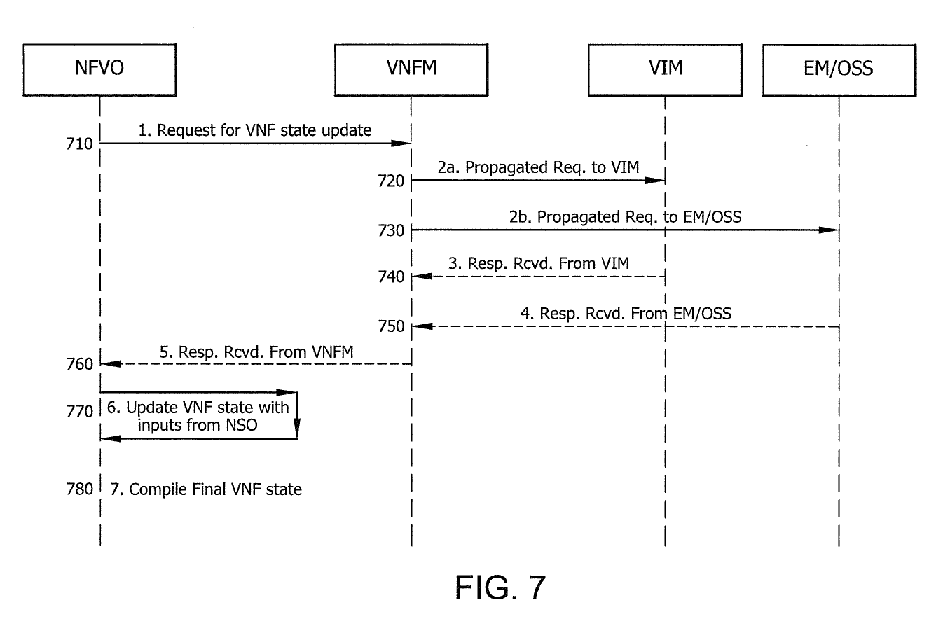

For the integrated (prior art) NFVO option, MANO blocks are as shown in FIG. 5, and actions are as shown in FIG. 7. As shown in FIG. 5, a pool of acceleration and adaptation resources 510 is maintained separately from the NFVO 520 and is accessed via an interface 530 therebetween. The pool may be physical or virtual or a combination of both. In addition, the NFVO 540 comprises integrated network services orchestrator (NSO) and resources orchestrator (RO).

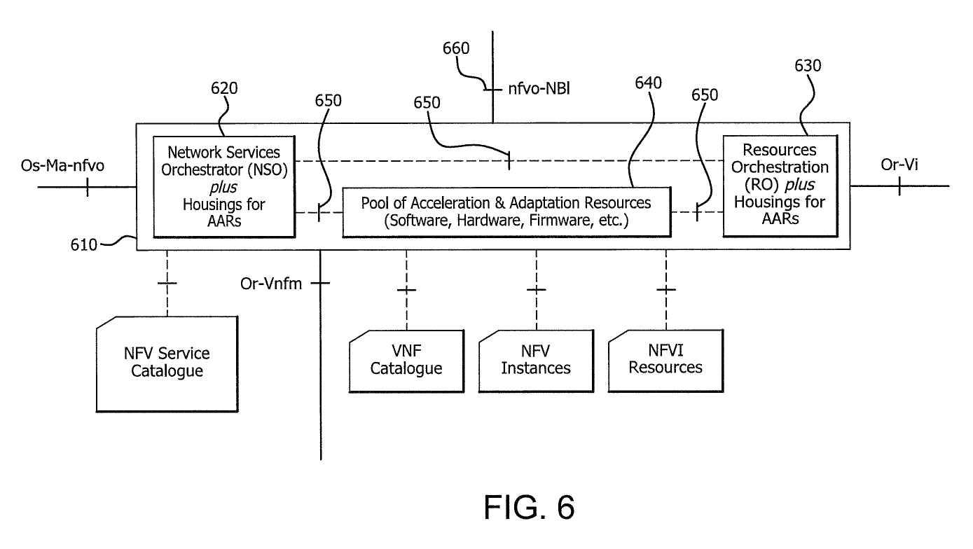

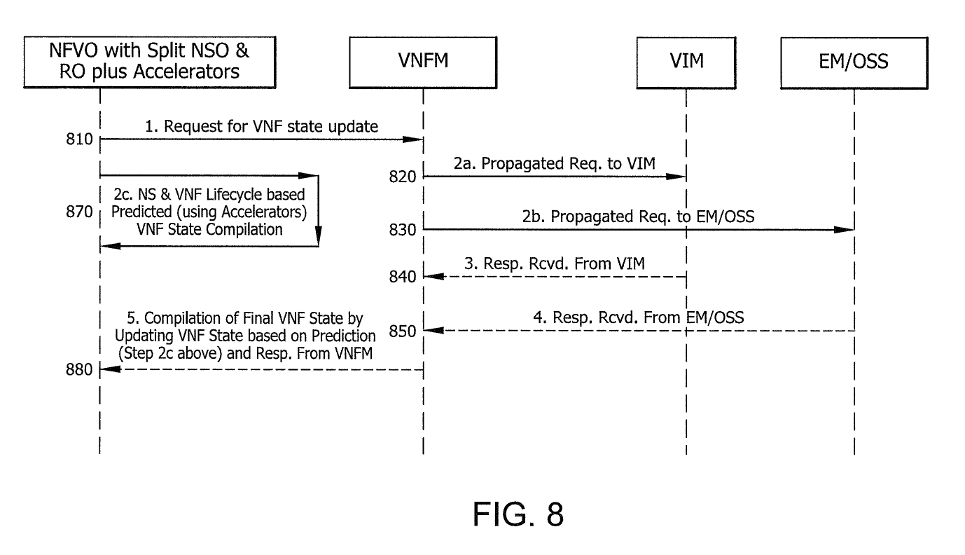

For the herein disclosed split NFVO option, the MANO blocks are as shown in FIG. 6, and actions involved are as shown in FIG. 8. FIG. 6 is a block diagram of the herein disclosed NFV Orchestrator (NFVO) block 610 with split NSO 620 and RO 630 sub-blocks. RO 630 may also comprise housings for acceleration and adaptation resources (AARs). Although NSO and RO sub-blocks are disclosed in the ETSI documents IFA 009 and IFA020 (previously mentioned and included herein by reference), those documents do not include the separation of NSO and RO disclosed herein.

Further, as shown in FIG. 6, NFVO 610 may also comprise as a sub-block a pool of AARs 540. The pool of acceleration and adaptation resources may include any of software, hardware, firmware, and the like. In addition, three new reference points 650 may be defined between each of the sub-blocks of NFVO block 610, for use in clarifying, allocation, usage, management, co-ordination, modification, and release of acceleration resources. One new reference point is disposed between the NSO and RO sub-blocks; another new reference point is disposed between the NSO sub-block and the acceleration resource pool sub-block; and yet another new reference point is disposed between the RO sub-block and the acceleration resource pool sub-block. These sub-blocks, and any other sub-blacks that may be comprised within NFVO, may contain agents for use in managing the usage of acceleration resources. The pool of acceleration resources may further contain agents for each of the NFVO sub-blacks that it serves.

In addition, a main reference point 660 “north bound” from the NFVO block, denoted nfvo-NBI, may be provided for use when a service spans multiple independently administered NFVO domains, and to support apps for managing new NFVO applications and services. It is noted that the use of accelerators in the NFVO/MANO interfaces may result in enhanced NFV architecture. However, details of these aspects are beyond the scope of the present disclosure.

As noted, FIG. 7 shows actions that pertain to the integrated NSO/RO option, and FIG. 8 shows actions that pertain to the split NSO-RO option, Both options include the NFVO requesting a VNF state update from the VNFM (710, 810); the VNFM propagating the request to VIM (720, 820), and to EM/OSS (730, 830). Both options also include the VNFM receiving responses from VIM (740, 840), and from FM/OSS (750, 850), and the NFVO receiving the responses from VNFM (760). The difference lies in how the final VNF states are determined.

FIG. 7 shows NFVO receiving the response from VNFM (760), updating its VNF state information with inputs from NSO (770), and compiling the final VNF state using the information and inputs (780), In contrast, FIG. 8 adds an orchestration acceleration step (870). In the illustrated example, acceleration step 870 includes predicting NS and VNF anticipated behavior based on their histories and using the prediction information in compiling the VNF state, although other acceleration mechanisms may alternatively or additionally be used. Because the final VNF state includes predictive information, it is likely to provide more timely and accurate state information when subsequently used in orchestration of resources in a VNF environment.

Although the invention has been described and illustrated in exemplary forms with a certain degree of particularity, it is noted that the description and illustrations have been made by way of example only. Numerous changes in the details of construction, combination, and arrangement of parts and steps may be made. Accordingly, such changes are intended to be included within the scope of the disclosure, the protected scope of which is defined by the claims. It should be appreciated that, while selected embodiments have been described herein for illustration purposes, various modifications may be made without deviating from the scope of the invention. Accordingly, the invention is not limited except as by the appended claims and the elements explicitly recited therein.

What is claimed is:

1. A method for accelerating orchestration of resources in a network function virtualization (NFV) environment, comprising:
requesting a virtualized network function (VNF) state update by a network function virtualization orchestrator (NFVO) having distinct network services orchestrator (NSO) and resources orchestration (RO);
receiving the request by a virtualized network function manager (VNFM);
propagating the received request to virtualized infrastructure manager (VIM) and element management (EM)/operation system support (OSS) by the VNFM;
obtaining and sending the requested VNF state information by the VIM, the EM/OSS, or both;
receiving the requested state information by the VNFM, and sending it to the NFVO; and
receiving the requested state information from the VNFM by the NFVO;
combining the received state information with acceleration information to accelerate compilation of a final VNF state by the NFVO, wherein the acceleration information is provided by a resource selected from a pool of acceleration/adaptation resources of the NFVO; and
using the final VNF state information in the orchestration of VNF by the NFVO.

2. The method of claim 1, wherein one of the NSO and the RO is the source of the request.

3. The method of claim 1, wherein the acceleration information includes at least one of stacked virtual resource information, look up/down information, pattern matching information, and look-ahead information.

4. The method of claim 1, wherein at least a portion of the acceleration information is provided by at least one application add-on for accelerating, adapting, or enhancing at least one of the RO, the NSO, and the NSVO.

5. The method of claim 1, further comprising virtualized network functions (VNF) publishing their state.

6. The method of claim 5, wherein the publishing uses an open API for at least one of NFVO, VNFM, and VIM to monitor and gather information about current and emerging states.

7. The method of claim 1, further comprising the NFVO pre-positioning resources for use by NS based on information of the states of NS.

8. The method of claim 1, further comprising the NFVO interfacing with at least one other NFVO to support a NS that spans a plurality of independently administered NFVO domains.

9. The method of claim 1, further comprising dynamically adding an accelerator to a NFVO sub-block to optimize operations.

10. A system for accelerating orchestration of resources in a network function virtualization (NFV) environment, comprising:
a network function virtualization orchestrator (NFVO) having a pool of acceleration and adaptation resources and distinct network services orchestrator (NSO) and resources orchestration (RO);
a virtualized network function manager (VNFM) communicatively coupled to the NFVO and to
a virtualized infrastructure manager (VIM) communicatively coupled to the NFVO; and
an element management (EM)/operation system support (OSS) block communicatively coupled to the VNFM.

11. The system of claim 10, wherein:
the NFVO requests a virtualized network function (VNF) state update;
the VNFM receives the request and propagates it to VIM and EM/OSS;
at least one of EM/OSS and VIM obtain and send the requested VNF state information;
the VNFM receives the state information and sends it to the NFVO;
the NFVO receives the requested state information from the VNFM and combines it with acceleration information to accelerate generating a final VNF state by the NFVO; and
using the final VNF state information in the orchestration of VNF by the NFVO.

12. The system of claim 10, wherein one of the NSO and the RO is the source of the request.

13. The system of claim 10, wherein the acceleration information includes at least one of stacked virtual resource information, look up/down information, pattern matching information, and look-ahead information.

14. The system of claim 10, wherein at least a portion of the acceleration information is provided by a plug-in anyware module.

15. The system of claim 10, wherein at least a portion of the acceleration information is provided by at least one application add-on for accelerating, adapting, or enhancing at least one of the RO, the NSO, and the NFVO.

16. The system of claim 10, further comprising virtualized network functions (VNFs) that publish their state.

17. The system of claim 16, wherein the publishing employs open APIs for at least one of NFVO, VNFM, and VIM to monitor and gather information about current and emerging states.

18. The system of claim 10, wherein NFVO pre-positions resources for use by NS based on information of the states of NS.

19. The system of claim 10, wherein the NFVO interfaces with at least one other NFVO to support a NS that spans a plurality of independently administered NFVO domains.

20. The system of claim 10, wherein an accelerator is dynamically added to a NFVO sub-block to optimize operations.
